(19) United States
(12) Patent Application Publication
(10) Pub. No.: US 2010/0187718 A1
(43) Pub. Date: Jul. 29, 2010

(54) RE-CAPSULATION OF SYNTHETIC RUBBER POLYMER

(76) Inventor: G. Mohammed Memon, Ashburn, VA (US)

Correspondence Address: LAUBSCHER & LAUBSCHER, P.C., 1160 SPA ROAD, SUITE 2B, ANNAPOLIS, MD, 21403, US

(21) Appl. No.: 12/360,406

(22) Filed: Jan. 27, 2009

(51) Int. Cl. B29C 47/00

(52) U.S. Cl. 264/211.12

(57) ABSTRACT

A method for making a modified polymer is characterized by re-capsulating the polymer via extrusion. A cross-linking agent is mixed with particles of synthetic rubber material to form a mixture which is then heated and delivered to an extrusion device. The extrusion device further heats the mixture and produces strands of modified polymer material which are cooled and pelletized to form small pellets of re-capsulated modified polymer. A partitioning or anti-blocking agent is added to the pellets to prevent re-agglomerization of the modified polymer. When mixed with asphalt, a modified polymer asphalt is produced with enhanced Theological properties for high and low temperatures.

### BACKGROUND OF THE INVENTION

Polymer modification is well known in the asphalt industry. Different types of polymers including ethylene propylene rubber (EPDM), styrene isoprene styrene (SIS), styrene butadiene styrene (SBS), styrene butadiene rubber (SBR), styrene butadiene (SB) block co-polymer and the like are used to modify asphalt for paving applications. Recently, styrene butadiene back bone polymers have gained momentum in the polymer modification of asphalt.

As polymer modification of asphalts (PMA) with SBS, SB, and SBR polymers continues to grow, the ability to produce sufficient quantities of polymer modified asphalt at a reasonable cost becomes more important. Improving the efficiency of the manufacture of polymer modified asphalt will enhance its use in the future.

The present invention relates to the re-capsulation of synthetic rubber polymer with a cross-linking agent. The cross-linking agent is a low melt chemical which assists the dispersion of the synthetic rubber polymer into asphalt more quickly. This reduces the time required to manufacture polymer modified asphalt.

### BRIEF DESCRIPTION OF THE PRIOR ART

Modified asphalt including polymer modified asphalt is well-known in the patented prior art as evidenced by the Memon U.S. Pat. Nos. 6,444,731 and 7,371,794. The '731 patent teaches the use of furfural or vegetable oil as a cross-linking agent with asphalt modifier material such as butadiene back bone polymers or crumb rubber to form a treated material which is quickly dispersed into asphalt. This increases the rate of production of polymer modified asphalt and also reduces the cost of production. The '794 patent teaches the use of a partitioning agent in the manufacture of polymer modified asphalt to prevent re-agglomeration of the polymer either standing alone or within the asphalt material. The resulting product is more homogeneous with improved low and high temperature rheological properties.

While the prior methods operate satisfactorily, there is a need for polymer modified asphalt production technique which has reduced reaction and dispersion times and an increased production rate. The present invention was developed in order to provide such a technique as well as a method for making a polymer modifier material which is easily transportable to an asphalt production facility.

### SUMMARY OF THE INVENTION

Accordingly, it is a primary object of the invention to provide a method for making a modified polymer where a cross-linking agent is mixed with particles of synthetic rubber material to form a mixture. The mixture is extruded and pelletized to form small pellets of modified polymer. The pellets are dusted with a partitioning agent to prevent re-agglomerization of the modified polymer. The mixture is preferably heated to a temperature of between 150° C. and 75° C. and extruded at a temperature of between 50° C. and 190° C. To assist the pelletizing step, the extruded mixture is cooled in water prior to delivery to a chopper of the pelletizer so that the material can be chopped into pellets of a desired size and configuration.

The synthetic rubber material is a butadiene back boned polymer or a block co-polymer and the cross-linking agent is a carrier material with an acidic activator. The activator preferably contains sulfur and the carrier material is a mineral oil. The partitioning agent is a mixture of a phenyl formaldehyde resin with a polyethylene wax, a polymethylene wax (Fisher-Tropsch wax) or a linear aliphatic hydrocarbon polymer.

The modified polymer pellets are mixed with hot asphalt having a temperature of between 160° C. and 220° C. to produce a modified asphalt material which has improved rheological, separation and solubility characteristics.

### BRIEF DESCRIPTION OF THE FIGURES

Other objects and advantages of the invention will become apparent from a study of the following specification when viewed in the light of the accompanying drawing, in which:

FIG. 1 is a block diagram illustrating the preferred method for making modified polymer according to the invention;

FIG. 2 is a photograph of re-capsulated polymer following extrusion;

FIG. 3 is a photograph of pelletized modified polymer material dusted with a partitioning agent; and

FIGS. 4 and 5 are fluorescent microscopic photographs of polymer modified asphalt incorporating re-capsulated polymer according to invention initially after mixing and 150 minutes after mixing, respectively.

### DETAILED DESCRIPTION

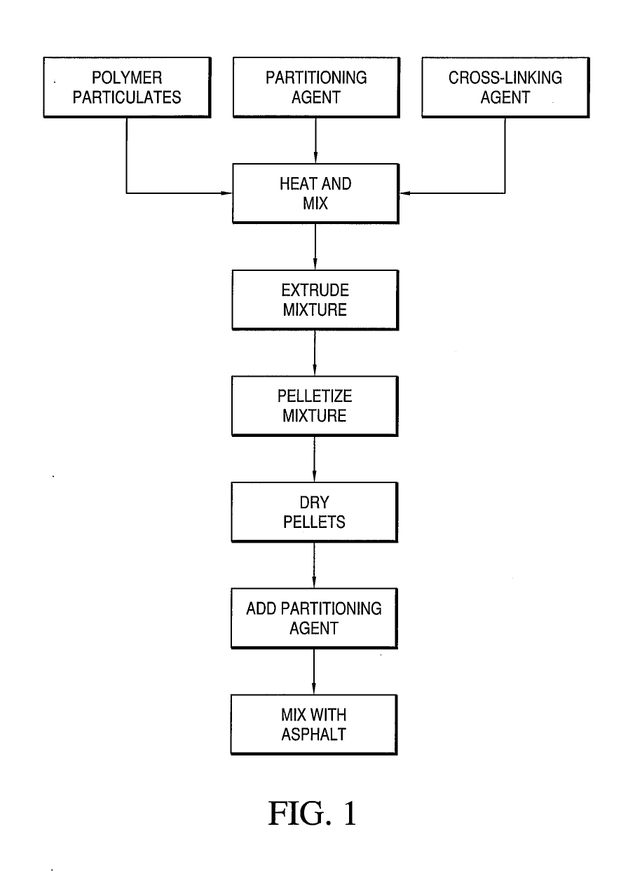

The preferred method for re-capsulating synthetic rubber polymer according to the invention will be described with reference to FIG. 1. Polymer particles are added to a hopper of a metering system of an extrusion machine. The preferred polymers are butadiene back boned polymers such as styrene butadiene (SB) block copolymer and styrene butadiene rubber (SBR). Also suitable for use according to the invention is a styrene butadiene styrene (SBS) polymer.

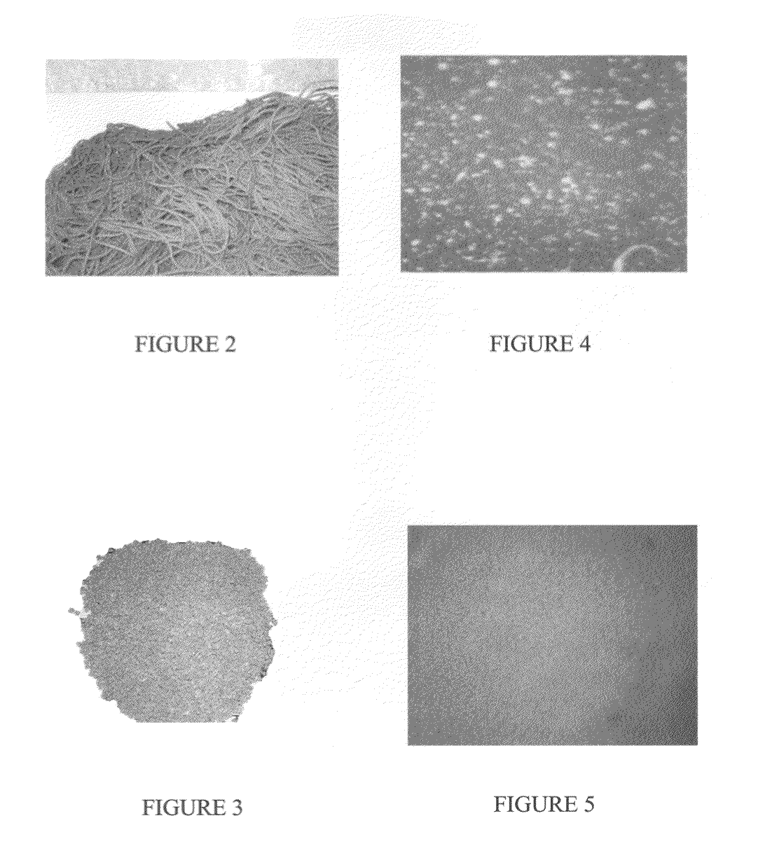

A cross-linking agent is also added to the hopper of the metering system for the extrusion machine. The cross-linking agent is formed of a carrier material with an acidic activator. The activator preferably contains a trace amount of sulfur and the carrier material preferably comprises mineral oil. The amount of polymer is generally between 80 and 99% by weight of the resulting mixture, and the amount of cross-linking agent is preferably between 1 and 20% by weight. The polymer is heated to a temperature of between 15° C. and 75° C. The mixture of polymer and cross-linking agent is fed through a twin screw extrusion device under mass and volume controls at an elevated temperature of between 50° C. and 190° C. to convert the mixture into a re-capsulated product. Emerging from the extruder, the re-capsulated product has a pliable consistency in the form of strands as shown in FIG. 2.

The strands exiting the extruder are cooled, preferably by submersing the same in chilled water so that the strands become rigid. The re-capsulated polymer material is then pelletized by chopping the rigid strands into pieces of a desired size. The chopping device may be arranged within the cooling water so that chopping occurs underwater to accelerate the cooling and pelletizing processes. The resulting pellets are then dried in a dryer. Next, the dry pellets are dusted with a partitioning or anti-blocking agent to prevent re-agglomerization of the polymer. In a preferred embodiment, the partitioning agent is a mixture of phenyl formaldehyde resin with a polyethylene wax, a polymethylene wax (Fisher-Tropsch wax), or a linear aliphatic hydrocarbon polymer. The amount of partitioning agent added to the pellets of re-capsulated polymer is between 0.05 and 10% by weight of the re-capsulated polymer. Pelletized re-capsulated polymer with a dusting of partitioning or anti-blocking agent is shown in FIG. 3.

Where the synthetic rubber used as the polymer material comprises a styrene butadiene (SB) polymer or certain styrene butadiene styrene (SBS) polymers, the partitioning agent may also be added to the hopper of the metering system for the extrusion device for mixing with the polymer particles and the cross-linking agent prior to extrusion. The amount of partitioning agent added is between 0.05 and 10% by weight of the re-capsulated polymer.

The resulting re-capsulated synthetic rubber polymer is then ready for packaging for shipping to an asphalt plant where the re-capsulated polymer may be mixed with the asphalt to form polymer modified asphalt. The resulting asphalt has improved rheological, separation, and solubility characteristics. These properties are set forth in Table I below:

TABLE I

| | | | Creep | | Elastic |
|---|---|---|---|---|---|
| | | DSR | Stiffness | | Recovery |
| Asphalt | PG-Grade | Value | of S-Value | m-Value | (E.R) |
| Base | 64-22 | 1.17 | 180 | 0.321 | 14% |
| PMA (SB)1205 | 94-22 | 2.878 | 145 | 0.324 | 81% |
| PMA (SBS)3522 | 77-22 | 1.29 | 101 | 0.328 | 56.25 |

As shown in the Table, the polymer network formed by the use of re-capsulated polymer enhances the rheological properties for both low and high temperatures and also satisfies the performance grades specified by various Departments of Transportation for use in road construction.

FIG. 4 is a fluorescent microscopic picture of polymer modified asphalt using the re-capsulated polymer according to the invention immediately after mixing with the polymer. This photograph shows the fluorescent light in the asphalt which is due to the double bond of butadiene of the polymer and indicates that the polymer molecules have not formed a network bond with the asphalt molecules. This asphalt is thus not stable and not suitable for storage. However, after approximately 150 minutes, the asphalt becomes stable because the double bond of the butadiene is completely broken allowing the polymer molecule to link with the asphalt molecule as shown in FIG. 5. The absence of fluorescent light indicates that the double bond of the butadiene has broken. The resulting modified asphalt is suitable for storage with no separation in the polymer modified asphalt.

While the preferred forms and embodiments of the invention have been illustrated and described, it will be apparent to those of ordinary skill in the art that various changes and modifications may be made without deviating from the inventive concepts set forth above.

1. A method for making a modified polymer, comprising the steps of (a) mixing a cross-linking agent with particles of synthetic rubber material to form a modified polymer mixture, said cross-linking agent comprising a carrier material with an acidic activator which contains sulfur, said carrier material including mineral oil;
(b) adding a partitioning agent to said modified polymer mixture to prevent re-agglomerization of said modified polymer mixture; and
mixing said modified polymer mixture with said hot asphalt to produce a modified asphalt material which has improved rheological, separation and solubility characteristics.

2. A method as defined in claim 13, and further comprising the step of cooling said strands of modified polymer following said extruding step.

3. A method as defined in claim 2, wherein said cooling step comprises passing said strands of modified polymer through water.

4. A method as defined in claim 2, wherein said heating step is performed at a temperature of between 15° C. and 75° C.

5. A method as defined in claim 4, wherein said extruding step is performed at a temperature of between 50° C. and 190° C.

6. A method as defined in claim 1, wherein said partitioning agent is added to said modified polymer mixture at a temperature of between 15° C. and 75° C.

7. A method as defined in claim 2, wherein said synthetic rubber material comprises a butadiene back bone polymer or a block co-polymer.

8. (canceled)

9. (canceled)

10. A method as defined in claim 6, wherein said partitioning agent comprises a mixture of a phenyl formaldehyde resin with a polyethylene wax, a polymethylene wax (Fisher-Tropsch wax), or a linear aliphatic hydrocarbon polymer.

11. A method as defined in claim 1, wherein said synthetic rubber material comprises styrene butadiene rubber or styrene butadiene styrene rubber, and further comprising the step of mixing a partitioning agent with said cross-linking agent and said particles of styrene butadiene rubber or styrene butadiene styrene rubber.

12. (canceled)

13. A method as defined in claim 1, and further comprising the steps of
(d) heating the modified polymer mixture;
(e) extruding the mixture into strands of modified polymer; and
(f) pelletizing the strands of modified polymer.
